(19) United States
(12) Patent Application Publication
(10) Pub. No.: US 2014/0358653 A1
(43) Pub. Date: Dec. 4, 2014

(54) ELECTRONIC COMMERCE SYSTEM AND METHOD APPLYING RANDOM DISCOUNT RATE WHEN BARGAIN IS REQUESTED

(71) Applicant: Sang Sun Han, Gyeonggi-do (KR)

(72) Inventor: Sang Sun Han, Gyeonggi-do (KR)

(21) Appl. No.: 13/943,372

(22) Filed: Jul. 16, 2013

(30) Foreign Application Priority Data
May 28, 2013 (KR) 10-2013-0060256

(51) Int. Cl. G06Q 30/02

(52) U.S. Cl. CPC G06Q 30/0222
USPC 705/14.14

(57) ABSTRACT

The present invention relates to an electronic commerce system and method applying a random discount rate when a bargain is requested. According to the present invention, a purchaser terminal connects to an electronic commerce server and selects a product from a sales site provided by the electronic commerce server, and the electronic commerce server confirms whether or not a bargaining function of the selected product is activated. If the electronic commerce server receives a request for bargaining a price of the selected product from the purchaser terminal while the bargaining function is activated, the electronic commerce server calculates a random discount rate in response to the bargaining request, notifies the purchaser terminal of the calculated discount rate and a price of the product to which the discount rate is applied, and performs a product purchase process according to the intention of the purchaser terminal for purchasing the selected product.

### CROSS-REFERENCE TO RELATED PATENT APPLICATIONS

This patent application claims the benefit of Korean Patent Application No. 10-2013-0060256, filed May 28, 2013, the teachings and disclosure of which are hereby incorporated in their entirety by reference thereto.

### BACKGROUND OF THE INVENTION

1. Field of the Invention

The present invention relates to an electronic commerce system and method applying a random discount rate when a bargain is requested, in which a random discount rate is provided each time when a bargain over a price of a product is requested so that a purchaser may determine whether or not to purchase the product.

2. Background of the Related Art

Electronic commerce, which is a type of transaction for selling and buying a product over the Internet, is generalized recently with the advancement in the Internet and communication techniques. The electronic commerce refers to all types of transactions for selling and buying goods or services in an online space.

In an electronic commerce shopping mall of a conventional technique, a transaction is made by a purchaser who determines purchase of a product at a predetermined price, i.e., at a static price. When a transaction is conducted at a static price, the purchaser determines whether or not to buy a product by confirming a price of the product moving around a large number of electronic commerce sites or by comparing prices of the same product in a separate price comparison site, and thus a lot of time is required, and interest of participants may not be stimulated.

In order to solve these problems, a transaction conducted through an auction, which is a preliminary stage of dynamic pricing, is proposed, and a transaction which allows a bargain between a purchaser and a seller in an online space is also proposed.

However, since such conventional techniques require a purchaser or a seller to discontinuously propose and confirm desired conditions by reconnecting to a corresponding website or through an e-mail, a lot of time is consumed in conducting electronic commerce, and thus interest of participants may not be stimulated, and a lot of changes of succeeding a transaction may be lost.

### SUMMARY OF THE INVENTION

Therefore, the present invention has been made in view of the above problems, and it is an object of the present invention to provide an electronic commerce system and method applying a random discount rate when a bargain is requested, in which a random discount rate is provided each time when a bargain over a price of a product is requested so that a purchaser may determine whether or not to purchase the product.

To accomplish the above object, according to one aspect of the present invention, there is provided an electronic commerce method applying a random discount rate when a bargain is requested, the method including the steps of: connecting, by a purchaser terminal, to an electronic commerce server; selecting, by the purchaser terminal, a product from a sales site provided by the electronic commerce server; confirming, by the electronic commerce server, whether or not a bargaining function of the selected product is activated; receiving, by the electronic commerce server, a request for bargaining a price of the selected product from the purchaser terminal while the bargaining function is activated; calculating, by the electronic commerce server, the random discount rate in response to the bargaining request; notifying, by the electronic commerce server, the purchaser terminal of the calculated discount rate and a price of the product to which the discount rate is applied; and performing, by the electronic commerce server, a product purchase process according to an intention of the purchaser terminal for purchasing the selected product.

In addition, if the bargaining function of the selected product is deactivated in the step of confirming whether or not a bargaining function is activated, the electronic commerce method of the present invention further includes the step of activating again the bargaining function of the selected product when a certain condition is satisfied.

In addition, if the bargaining function of the selected product is deactivated in the step of confirming whether or not a bargaining function is activated, a price of the product discounted through previous price bargaining is displayed on a product web page for the selected product.

The step of calculating a discount rate calculates the random discount rate by generating a random number using information on a time of receiving the request for bargaining a price from the purchaser terminal.

The step of performing a product purchase process includes the steps of: deactivating the bargaining function of the corresponding product if the selected product is not purchased; and activating the bargaining function of the corresponding product when a certain condition is satisfied after the bargaining function is deactivated.

The certain condition is confirming whether or not a predetermined time is elapsed after the request for bargaining a price is generated for the selected product.

In addition, according to another aspect of the present invention, there is provided an electronic commerce system applying a random discount rate when a bargain is requested, the system including: a purchaser terminal 100 connecting to a sales site and trying purchase of a product; and an electronic commerce server 200 for providing the sales site, randomly calculating the discount rate if a bargain is requested for a product selected by the purchaser terminal, notifying the purchaser terminal of the calculated discount rate and a price of the product to which the calculated discount rate is applied, and performing a product purchase process according to whether or not the purchaser terminal requests to purchase the product.

The electronic commerce server 200 includes: a sales site operation unit 210 for providing the sales site and notifying the purchaser terminal of the discount rate determined for the corresponding product and the price of the product to which the calculated discount rate is applied, if a bargain is requested for the selected product; a discount rate calculation unit 220 for calculating the random discount rate by generating a random number using information on a time of receiving the request for bargaining a price of the selected product; and a payment processing unit 230 for performing a payment process for the corresponding product at a price applying the calculated discount rate, if a payment request according to purchase of the selected product is received from the sales site operation unit.

When a certain condition is satisfied after a bargaining function of the selected product is deactivated, the sales site operation unit 210 activates again the bargaining function of the corresponding product.

When the purchase process is completed for the selected product, the sales site operation unit 210 accumulates a predetermined proportion of a purchase amount as mileage based on a membership class of a purchaser.

Since the present invention provides a randomly calculated discount rate when a request for bargaining a price of a product is received, a discount rate proposed to each purchaser is different for the same product.

Furthermore, the present invention provides a different discount rate for the same product proposed to the same purchaser. Accordingly, since the purchaser may confirm the proposed discount rate and determine whether or not to purchase the product depending on whether or not the discount rate is satisfied, satisfaction of the purchaser with the price of the product may be increased.

### BRIEF DESCRIPTION OF THE DRAWINGS

FIG. 1 is a view showing the configuration of an electronic commerce system applying a random discount rate when a bargain is requested according to the present invention.

FIG. 2 is a flowchart illustrating an electronic commerce method applying a random discount rate when a bargain is requested according to the present invention.

FIG. 3 is an exemplary view showing a product web page when a bargaining function is activated according to the present invention.

FIG. 4 is a view showing an example of displaying a randomly calculated discount rate according to the present invention.

FIG. 5 is an exemplary view showing a product web page reflecting a calculated discount rate according to the present invention.

### DESCRIPTION OF SYMBOLS

100: Purchaser terminal
200: Electronic commerce server
210: Sales site operation unit
220: Discount rate calculation unit
230: Payment processing unit
300: Database
310: Member information DB
320: Product information DB
330: Mileage DB

### DETAILED DESCRIPTION OF THE PREFERRED EMBODIMENT

The preferred embodiments of the invention will be hereafter described in detail, with reference to the accompanying drawings.

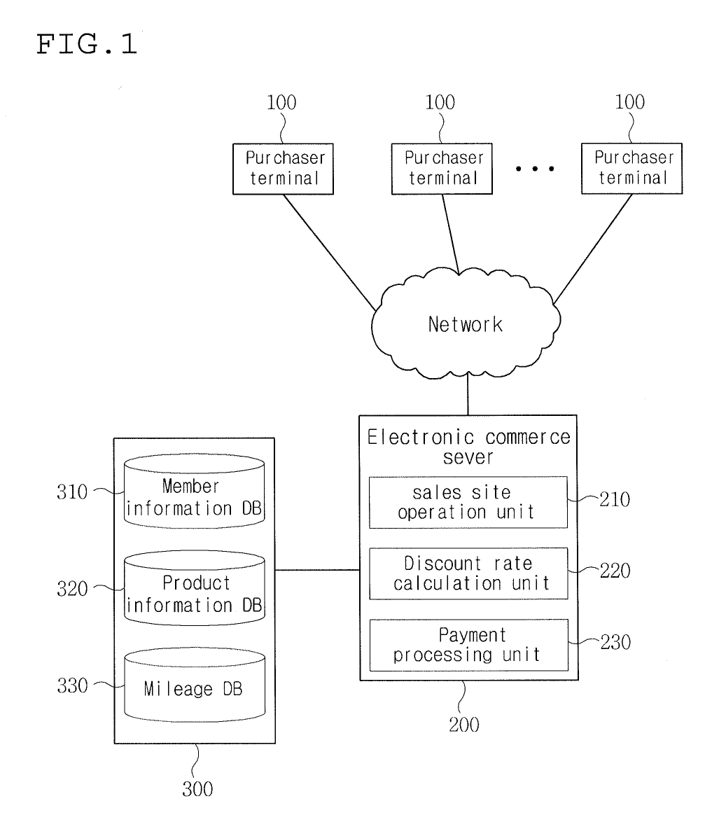

FIG. 1 is a view showing the configuration of an electronic commerce system applying a random discount rate when a bargain is requested according to the present invention.

Referring to FIG. 1, one or more purchaser terminals 100 and an electronic commerce server 200 operating a sales site are connected through a network. Here, the network may be implemented in a LAN, a wireless LAN, a mobile communication network or the like.

The purchaser terminal 100 may be implemented in a desktop computer, a notebook computer, a smart phone, a PDA (personal digital assistant) or the like and has hardware (communication module) that can communicate with the electronic commerce server 200 through the network. In addition, the purchaser terminal 100 has a web browser for receiving a web document of a sales site provided by the electronic commerce server 200 and displaying the web document on a display screen.

The purchaser terminal 100 may connect to the electronic commerce server 200 through the network, select a product desired to be purchased, and request a bargain over the selected product. In other words, the purchaser terminal 100 connects to a sales site provided by the electronic commerce server 200 using a web browser and selects any one of products registered in the sales site. Then, the purchaser terminal 100 requests a bargain over a price of the selected product.

The purchaser terminal 100 is informed of a discount rate of the product for which a bargain over a price is requested from the electronic commerce server 200 and transmits information on the intention of purchasing the product to the electronic commerce server 200 based on the discount rate. That is, a user may request a bargain over a price of the selected product and determine whether or not to buy the product after receiving a discount rate of the product and a price of the product (selling price) calculated by applying the discount rate.

The electronic commerce server 200 includes a sales site operation unit 210, a discount rate calculation unit 220 and a payment processing unit 230. The electronic commerce server 200 includes a database 300 for recording, updating and deleting a variety of information input from the purchaser terminal 100 and a variety of information generated by interactions occurred in the electronic commerce server 200. The database 300 includes a member information database 310 for storing member information, a product information database 320 for storing product information and a mileage database 330 for managing records of purchase of each member.

The sales site operation unit 210 provides and manages a sales site. In addition, if the sales site operation unit 210 receives a request for joining a member from the purchaser terminal 100, it provides the purchaser terminal 100 with a member registration web page. The sales site operation unit 210 receives user information needed for registering the member from the purchaser terminal 100 through the member registration web page and stores the received user information in the member information database 310 as member information. Here, the member information includes an ID, a password, a name, a cellular phone number, an e-mail address, a mailing address and the like. When the procedure of joining a member is completed, the purchaser terminal 100 may connect to the sales site after acquiring membership authentication using membership authentication information such as the ID and the password.

If the purchaser terminal 100 connecting to the sales site selects any one of products registered in the sales site, the sales site operation unit 210 reads information on the selected product from the product information database 320, configures a product web page in a predetermined form, and transmits the product web page to the purchaser terminal 100. At this point, the sales site operation unit 210 confirms whether or not a bargaining function of the product selected by the purchaser terminal 100 is activated. That is, the sales site operation unit 210 confirms whether or not a bargain is requested on the same date for the product selected by the purchaser terminal 100. If the bargaining function of the selected product is not activated, the sales site operation unit 210 inserts a price that is already discounted through a bargaining process in the product web page.

If the purchaser terminal 100 requests a bargain over a price of the selected product while the bargaining function of the selected product is activated, the sales site operation unit 210 provides the purchaser terminal 100 with a randomly determined discounted rate and a price of the product to which the discount rate is applied (a bargained price) in response to the request.

If a request for purchasing the corresponding product is received from the purchaser terminal 100 after a result of bargaining over the selected product is provided to the purchaser terminal 100, the sales site operation unit 210 performs a product purchase process. The sales site operation unit 210 deactivates the bargaining function of the product selected by the purchaser terminal 100 when the product purchase process is completed and activates the bargaining function of the product when a certain condition is satisfied. For example, the sales site operation unit 210 may collectively activate bargaining functions at midnight for the products the bargaining function of which is deactivated or activate a bargaining function of a corresponding product when a predetermined time is elapsed from a time point when the bargaining function of the product is deactivated.

In addition, when the product purchase process is completed, the sales site operation unit 210 accumulates a predetermined proportion of the purchase price of the product as mileage (points) based on a membership class of a corresponding purchaser. That is, the sales site operation unit 210 updates mileage of the purchaser in association with the mileage database 330. For example, the sales site operation unit 210 accumulates 3% of the purchase price if the purchaser is a general member and 5% of the purchase price if the purchaser is a gold member.

The sales site operation unit 210 deactivates the bargaining function of the product selected by the purchaser terminal 100 if a response of the purchaser terminal 100 to a result of the bargaining the price is not to purchase the product and activates the bargaining function of the corresponding product when a certain condition is satisfied.

Although it is described as an example to deactivate the bargaining function of a corresponding product after determining whether or not to purchase the product for which the price is bargained, the present is not limited thereto, but the sales site operation unit 210 may be implemented to change the bargaining function of a corresponding product from an active state to an inactive state when the sales site operation unit 210 receives a request for bargaining a price from the purchaser terminal 100.

The discount rate calculation unit 220 randomly determines a discount rate for the product selected by the purchaser terminal 100 under the control of the sales site operation unit 210. For example, the discount rate calculation unit 220 calculates a discount rate for a corresponding product by generating a random number using information on the time of receiving the request for bargaining a price of the selected product. Accordingly, in the present invention, since a discount rate is randomly calculated each time when bargaining a price is requested, the discount rate of each purchaser is different for the same product.

The payment processing unit 230 performs a payment process for the product requested to be purchased in response to the request of the sales site operation unit 210. In other words, the payment processing unit 230 receives a payment means for the product requested to be purchased and information on the payment means from the purchaser terminal 100 and exchanges a request for approving the payment means and a result of approving the payment means with a banking system (not shown).

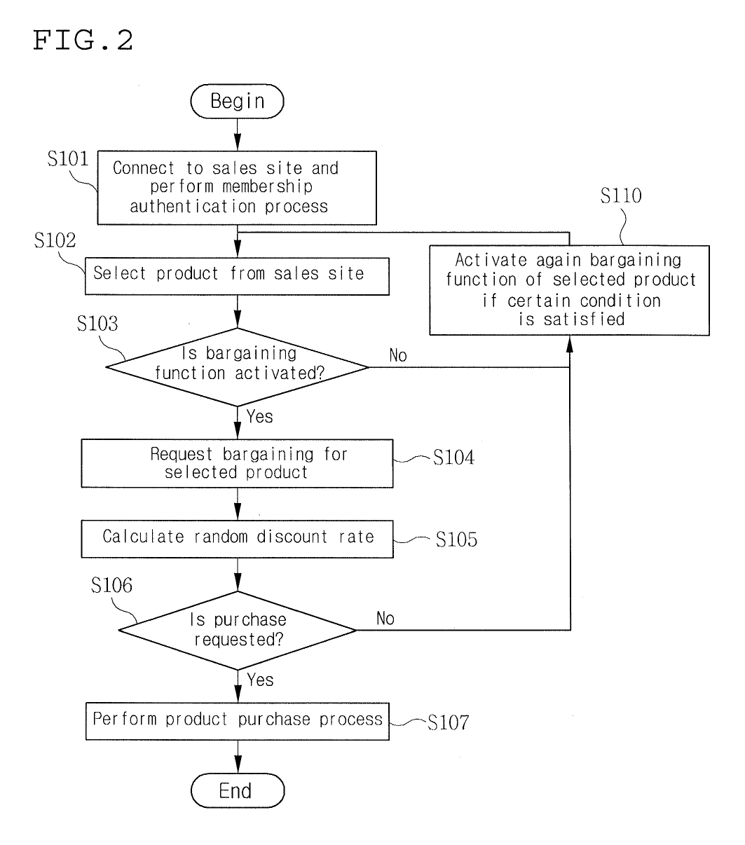

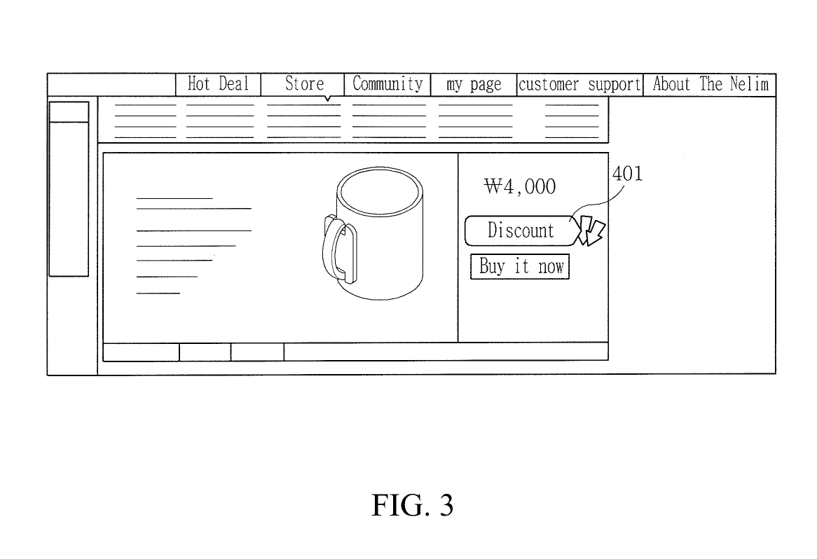

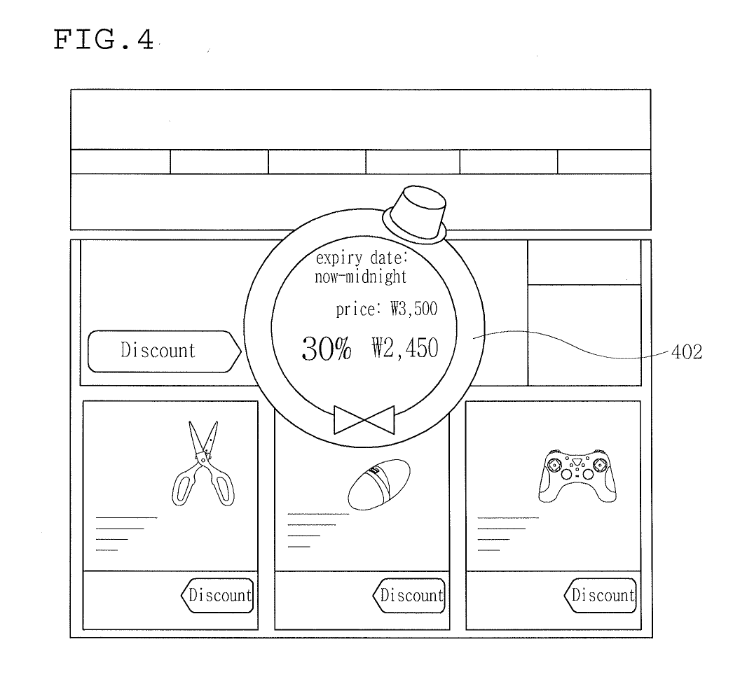

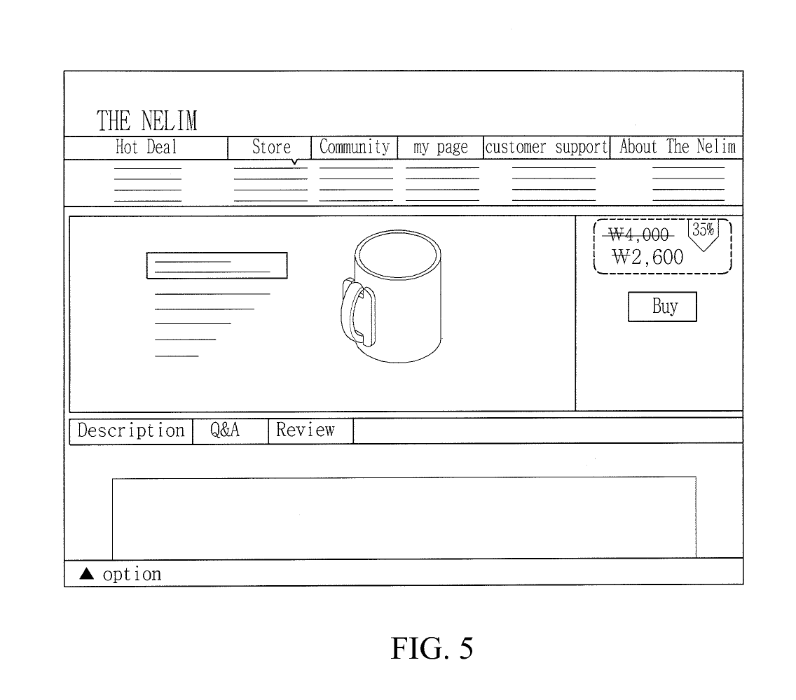

FIG. 2 is a flowchart illustrating an electronic commerce method applying a random discount rate when a bargain is requested according to the present invention, FIG. 3 is an exemplary view showing a product web page when a bargaining function is activated according to the present invention, FIG. 4 is a view showing an example of displaying a randomly calculated discount rate according to the present invention, and FIG. 5 is an exemplary view showing a product web page reflecting a calculated discount rate according to the present invention.

First, the purchaser terminal 100 connects to a sales site provided by the electronic commerce server 200 through a network 5101. At this point, the purchaser terminal 100 requests membership authentication by transmitting membership authentication information such as an ID and a password to the electronic commerce server 200 after connecting to the sales site. The electronic commerce server 200 permits login if membership information corresponding to the membership authentication information exists in the member information database 310 and blocks login if membership information corresponding to the membership authentication information does not exist in the member information database 310.

If a user selects any one of products registered in the sales site to which the purchaser terminal 100 connects, information unique to the selected product (e.g., a product number) is transmitted to the electronic commerce server 200 S102.

If the purchaser terminal 100 selects a product, the electronic commerce server 200 confirms whether or not a bargaining function of the selected product is activated 5103. The electronic commerce server 200 reads information on the selected product from the product information database 320 and creates a product web page in a predetermined form as shown in FIG. 3. At this point, the electronic commerce server 200 confirms whether or not the bargaining function of the selected product is activated and activates or deactivates a bargaining icon (‘discount’) 401 displayed on the product web page. In addition, the electronic commerce server 200 transmits the created product web page to the purchaser terminal 100 so that the product web page may be displayed on the display screen of the purchaser terminal 100.

While the bargaining function is activated, the electronic commerce server 200 receives a request for bargaining a price of the selected product from the purchaser terminal 100 S104. In other words, the electronic commerce server 200 confirms whether or not a request for bargaining a price of the selected product is received from the purchaser terminal 100.

If a request for bargaining a price is received from the purchaser terminal 100, the electronic commerce server 200 calculates a random discount rate for the corresponding product 5105. Here, the electronic commerce server 200 changes the bargaining function of the product for which bargaining a price is requested to an inactive state. Then, the electronic commerce server 200 calculates a discounted price (a selling price) of the product to which the calculated discount rate is applied.

The electronic commerce server 200 transmits the calculated discount rate and the discounted product price to the purchaser terminal 100 as a result of the bargaining. The purchaser terminal 100 displays the result of the bargaining in the form of a pop-up window as shown in FIG. 4, which will be disappeared after a predetermined time period. Then, the purchaser terminal 100 displays the price of the product discounted through the bargaining on the product web page as shown in FIG. 5.

Then, the electronic commerce server 200 confirms whether or not purchase of the product for which a price is bargained is requested from the purchaser terminal 100 S106.

If purchase of the product is requested from the purchaser terminal 100, the electronic commerce server 200 performs a product purchase process for the corresponding product S107.

If purchase of the product is not requested from the purchaser terminal 100 in step S106, the electronic commerce server 200 activates again the bargaining function of the corresponding product when a certain condition is satisfied S110. For example, the electronic commerce server 200 transits the bargaining function of the product for which the price is bargained from an inactive state to an active state at midnight.

On the other hand, when the purchaser terminal 100 requests purchase of the product as a non-member of the sales site, the electronic commerce server 200 performs a product purchase process for the product selected by the purchaser terminal 100 at a regular price since a bargaining function is not provided to a non-member.

As described above, the present invention limits the number of times that the purchaser terminal 100 may request to bargain a price for the same product. For example, the number of times of requesting a bargain over a price may be limited to once a day for each product. However, it is not limited thereto and may be changed by an operator operating the sales site.

In addition, since the present invention provides a different discount rate each time when the same purchaser requests a bargain over a price for the same product, a purchaser may confirm a bargained price and determine purchase of the product. That is, since the present invention finally determines a price of a product depending on the intention of the purchaser confirming the discount rate proposed by the sales site, satisfaction of the purchaser with the purchase price of the product may be increased.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An electronic commerce method applying a random discount rate when a bargain is requested, the method comprising the steps of:
connecting, by a purchaser terminal, to an electronic commerce server;
selecting, by the purchaser terminal, a product from a sales site provided by the electronic commerce server;
confirming, by the electronic commerce server, whether or not a bargaining function of the selected product is activated;
receiving, by the electronic commerce server, a request for bargaining a price of the selected product from the purchaser terminal while the bargaining function is activated;
calculating, by the electronic commerce server, the random discount rate in response to the bargaining request;
notifying, by the electronic commerce server, the purchaser terminal of the calculated discount rate and a price of the product to which the discount rate is applied; and
performing, by the electronic commerce server, a product purchase process according to an intention of the purchaser terminal for purchasing the selected product.

2. The method according to claim 1, further comprising, if the bargaining function of the selected product is deactivated in the step of confirming whether or not a bargaining function is activated, the step of activating again the bargaining function of the selected product when a certain condition is satisfied.

3. The method according to claim 1, wherein if the bargaining function of the selected product is deactivated in the step of confirming whether or not a bargaining function is activated, a price of the product discounted through previous price bargaining is displayed on a product web page for the selected product.

4. The method according to claim 1, wherein the step of calculating a discount rate calculates the random discount rate by generating a random number using information on a time of receiving the request for bargaining a price from the purchaser terminal.

5. The method according to claim 1, wherein the step of performing a product purchase process includes the steps of:
deactivating the bargaining function of the corresponding product if the selected product is not purchased; and
activating the bargaining function of the corresponding product when a certain condition is satisfied after the bargaining function is deactivated.

6. The method according to claim 3, wherein the certain condition is confirming whether or not a predetermined time is elapsed after the request for bargaining a price is generated for the selected product.

7. The method according to claim 5, wherein the certain condition is confirming whether or not a predetermined time is elapsed after the request for bargaining a price is generated for the selected product.

8. An electronic commerce system applying a random discount rate when a bargain is requested, the system comprising:
a purchaser terminal (100) connecting to a sales site and trying purchase of a product; and
an electronic commerce server (200) for providing the sales site, randomly calculating the discount rate if a bargain is requested for a product selected by the purchaser terminal, notifying the purchaser terminal of the calculated discount rate and a price of the product to which the calculated discount rate is applied, and performing a product purchase process according to whether or not the purchaser terminal requests to purchase the product.

9. The method according to claim 8, wherein the electronic commerce server (200) includes:
a sales site operation unit (210) for providing the sales site and notifying the purchaser terminal of the discount rate determined for the corresponding product and the price of the product to which the calculated discount rate is applied, if a bargain is requested for the selected product;
a discount rate calculation unit (220) for calculating the random discount rate by generating a random number using information on a time of receiving the request for bargaining a price of the selected product; and
a payment processing unit (230) for performing a payment process for the corresponding product at a price applying the calculated discount rate, if a payment request according to purchase of the selected product is received from the sales site operation unit.

10. The method according to claim 9, wherein when a certain condition is satisfied after a bargaining function of the selected product is deactivated, the sales site operation unit (210) activates again the bargaining function of the corresponding product.

11. The method according to claim 9, wherein when the purchase process is completed for the selected product, the sales site operation unit (210) accumulates a predetermined proportion of a purchase amount as mileage based on a membership class of a purchaser.
